(19) United States
(12) Patent Application Publication
(10) Pub. No.: US 2014/0313089 A1
(43) Pub. Date: Oct. 23, 2014

(54) MULTI-ANTENNA SYSTEM

(71) Applicant: Industrial Technology Research Institute, Hsinchu (TW)

(72) Inventors: Chun-Yih Wu, Taipei City (TW); Wei-Ji Chen, Tainan City (TW); Chin-Hung Wang, Hsinchu City (TW)

(21) Appl. No.: 13/933,133

(22) Filed: Jul. 2, 2013

(30) Foreign Application Priority Data
Apr. 18, 2013 (TW) 102113806

(51) Int. Cl. H01Q 3/30; H01Q 5/01

(52) U.S. Cl. CPC H01Q 3/30; H01Q 5/01
USPC 343/745; 343/893

(57) ABSTRACT

A multi-antenna system including a substrate, a ground element, a first antenna element, a second antenna element and a decoupling element is provided. The ground element is disposed on a first surface of the substrate, and the decoupling element is disposed on a second surface of the substrate. Ground portions of the two antenna elements and a first connection terminal of the decoupling element are electrically connected to the ground element. The decoupling element is spaced a first decoupling distance from a part of the first ground portion, and the decoupling element is spaced a second decoupling distance from a part of the second ground portion. A phase difference relative to the two antenna elements is generated by the decoupling element, the first decoupling distance and the second decoupling distance so as to eliminate interference energy between the two antenna elements.

### CROSS-REFERENCE TO RELATED APPLICATION

This application claims the priority benefit of Taiwan application serial no. 102113806, filed on Apr. 18, 2013. The entirety of the above-mentioned patent application is hereby incorporated by reference herein and made a part of this specification.

### TECHNICAL FIELD

The disclosure relates to a multi-antenna system. Particularly, the disclosure relates to a multi-antenna system having a decoupling element.

### BACKGROUND

Since a 4^{th} generation (4G) mobile communication long-term evolution (LTE) standard can support applications of a multi-antenna system having multi-input multi-output (MIMO), the 4G LTE standard has gradually become a new specification of mobile communication devices. However, since the LTE bands currently planned and adopted by various national market are too wide, for example, the American market adopts LTE700 band (704-862 MHz), the China and the European market adopts LTE2300 and LTE2600 bands (2300-26900 MHz), integration of the multi-antenna system faces new technical challenges.

For example, taking a multi-antenna system applied to an LTE dual-band as an example, since a low frequency band of the multi-antenna system covers 700 MHz and a high frequency band thereof covers 2.6 GHz, a resonant size of a low frequency antenna is generally above three times greater than that of a high frequency antenna. Besides the resonant size of the antenna is increased and an isolation distance between the antennas is decreased, significant increase of an operation wavelength of the antenna also makes a mutual coupling effect between the antennas more intense, which decreases radiation efficiency of the antenna.

A general decoupling technique generally adopts long distance placement between antennas to achieve a spatial diversity effect. For example, in U.S. Pat. No. 6,498,591 B2 and U.S. Pat. No. 7,253,779 B2, different antenna structures (patch, dipole) are used to achieve different radiation patterns, so as to achieve pattern diversity or polarization diversity. However, the aforementioned method may consume a large hardware space and cannot satisfy the requirements of lightness, slimness, shortness and smallness for the mobile communication devices.

Moreover, since the hardware space of the mobile communication device is limited, a decoupling technique having a design concept of a neutral line is developed, for example, multi-antenna structures disclosed by U.S. Patent No. US 2011/0175792 A1 and U.S. Patent No. US 2012/0013519 A1. However, although the aforementioned method can decrease a placement distance between the antennas, it can only form a narrowband isolation mode around a high frequency of 2.4 GHz, and if the aforementioned method is applied to the low frequency band of 700 MHz in the LTE system, a structure size of the neutral line deign is accordingly increased to occupy an antenna space or a circuit layout space, which limits the application range of the multi-antenna system.

### SUMMARY

The disclosure is directed to an antenna system, in which a decoupling element is used to improve isolation between two antenna elements.

An embodiment of the disclosure provides a multi-antenna system including a substrate, a ground element, a first antenna element, a second antenna element and a decoupling element. The substrate has a first surface and a second surface. The ground element is disposed on the first surface. The first antenna element includes a first ground portion electrically connected to the ground element. The second antenna element includes a second ground portion electrically connected to the ground element. The decoupling element is disposed on the second surface, and is opposite to the ground element with the substrate in between. Moreover, the decoupling element has a first connection terminal and a second connection terminal, and the first connection terminal is electrically connected to the ground element. The decoupling element and a part of the first ground portion are parallel to each other and are spaced by a first decoupling distance, and the decoupling element and a part of the second ground portion are parallel to each other and are spaced by a second decoupling distance. A phase difference relative to the first antenna element and the second antenna element is generated by the decoupling element, the first decoupling distance and the second decoupling distance.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic diagram of a multi-antenna system according to an embodiment of the disclosure.

FIG. 1B is a curve diagram of scattering parameters of a multi-antenna system according to an embodiment of the disclosure.

FIG. 2 and FIG. 3 are respectively schematic diagrams of a multi-antenna system according to another embodiment of the disclosure.

FIG. 4 is a schematic diagram of a multi-antenna system according to still another embodiment of the disclosure.

FIG. 5 is a perspective view of the multi-antenna system of FIG. 1A.

FIG. 6A is a schematic diagram of a multi-antenna system according to still another embodiment of the disclosure.

FIG. 6B is a curve diagram of measured scattering parameters of a multi-antenna system according to still another embodiment of the disclosure.

FIG. 7 is a schematic diagram of a phase combination structure according to an embodiment of the disclosure.

FIG. 8 is an extending embodiment of the phase combination structure of FIG. 7.

FIG. 9 is a schematic diagram of a phase combination structure according to another embodiment of the disclosure.

FIG. 10 is a schematic diagram of a multi-antenna system according to still another embodiment of the disclosure.

### DETAILED DESCRIPTION OF DISCLOSED EMBODIMENTS

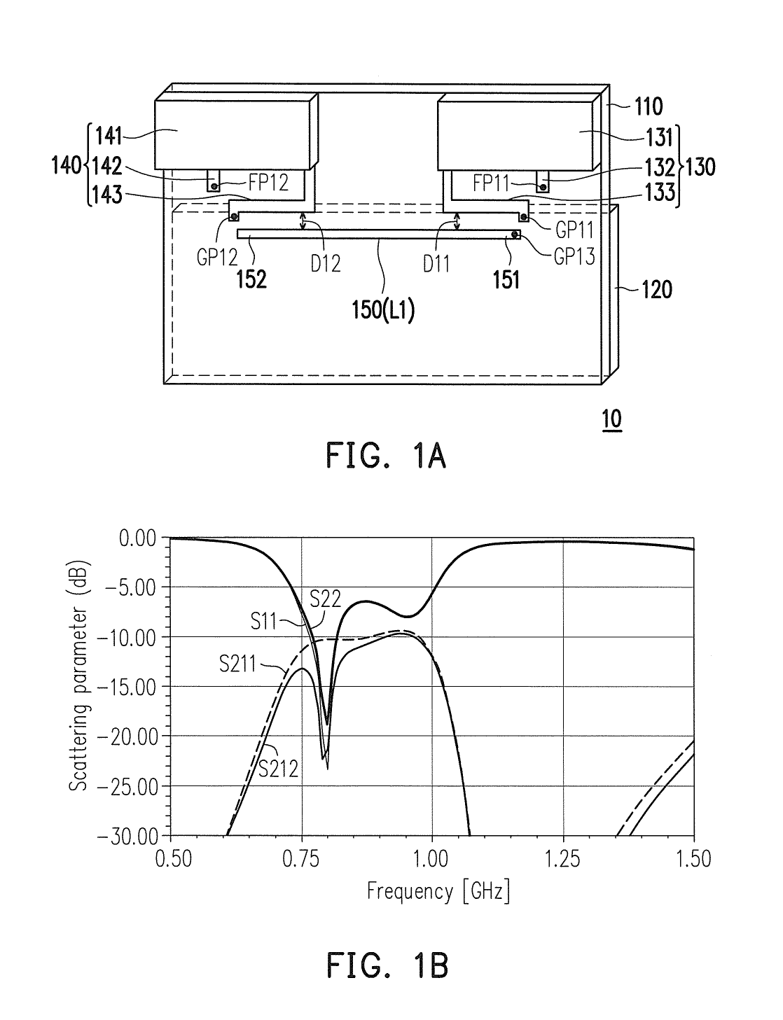

FIG. 1A is a schematic diagram of a multi-antenna system according to an embodiment of the disclosure. Referring to FIG. 1A, the multi-antenna system 10 includes a substrate 110, a ground element 120, a first antenna element 130, a second antenna element 140 and a decoupling element 150. The substrate 110 has a first surface and a second surface. The ground element 120 is equivalent to a system ground surface of the multi-antenna system 10, and is disposed on the first surface of the substrate 110. The decoupling element 150 is disposed on the second surface of the substrate 110. Moreover, an area on the first surface of the substrate 110 that is not configured with the ground element 120 can be regarded as a clearance area of the antenna.

The first antenna element 130 includes a first radiation portion 131, a first feeding portion 132 and a first ground portion 133. The first feeding portion 132 and the first ground portion 133 are electrically connected to the first radiation portion 131. Moreover, the first feeding portion 132 has a first feeding point FP11 configured to receive a feeding signal. The first ground portion 133 has a first ground point GP11 for electrically connecting the ground element 120. For example, in an embodiment, the multi-antenna system 10 further includes a first via, wherein the first via penetrates through the first ground portion 133, the substrate 110 and the ground element 120. Accordingly, the first ground point GP11 on the first ground portion 133 can be electrically connected to the ground element 120 through a conductive element in the first via.

The second antenna element 140 is located adjacent to the first antenna element 130, and includes a second radiation portion 141, a second feeding portion 142 and a second ground portion 143. The second feeding portion 142 and the second ground portion 143 are electrically connected to the second radiation portion 141. Moreover, the second feeding portion 142 has a second feeding point FP 12 configured to receive another feeding signal. The second ground portion 143 has a second ground point GP12 for electrically connecting the ground element 120. For example, in an embodiment, the multi-antenna system 10 further includes a second via, wherein the second via penetrates through the second ground portion 143, the substrate 110 and the ground element 120. In this way, the second ground point GP12 on the second ground portion 143 can be electrically connected to the ground element 120 through a conductive element in the second via.

The decoupling element 150 is opposite to the ground element 120 with the substrate 110 in between. Namely, the ground element 120 is disposed under the decoupling element 150. Moreover, the decoupling element 150 and a part of the first ground portion 133 are parallel to each other and are spaced by a first decoupling distance D11. Similarly, the decoupling element 150 and a part of the second ground portion 143 are parallel to each other and are spaced by a second decoupling distance D12. In the embodiment of FIG. 1A, the first ground portion 133 and the second ground portion 143 respectively have at least one bending portion to respectively form a section parallel to the decoupling element 150.

In operation, the lowest operating frequency of the first antenna element 130 is not greater than (i.e. smaller than or equal to) that of the second antenna element 140. Moreover, a phase difference relative to the first antenna element 130 and the second antenna element 140 is generated through the decoupling element 150, the first decoupling distance D11 and the second decoupling distance D12, so as to effectively eliminate interference of the resonant modes excited by the two antenna elements 130 and 140.

In other words, in the multi-antenna system 10, the interference energy between the two antenna elements 130 and 140 can be decreased through the decoupling element 150, so as to improve isolation between the two antenna elements 130 and 140. For example, FIG. 1B is a curve diagram of scattering parameter of a multi-antenna system according to an embodiment of the disclosure, in which curves S11 and S22 are used to represent return loss of the two antenna elements 130 and 140, and curves S211 and S212 are used to represent isolations of the multi-antenna system 10 before and after the decoupling element 150 is added. Referring to FIG. 1B, it is discovered that after the decoupling element 15 is added, the isolation between the antenna elements is obviously enhanced. Accordingly, the multi-antenna system 10 of the present embodiment can enhance isolation between the antenna elements without spacing the antennas by a long distance, so as to satisfy the requirements of lightness, slimness, shortness and smallness for a mobile communication device.

It should be noticed that the first decoupling distance D11 and the second decoupling distance D12 are all smaller than one percent of a wavelength of the lowest operating frequency of the first antenna element 130. Moreover, the first ground portion 133 has a section parallel to the decoupling element 150, and a length of the section is not smaller than one percent of the wavelength of the lowest operating frequency of the first antenna element 130. Similarly, the second ground portion 143 has a section parallel to the decoupling element 150, and a length of the section is not smaller than one percent of the wavelength of the lowest operating frequency of the first antenna element 130.

In the embodiment of FIG. 1A, the decoupling element 150 has a first connection terminal 151 and a second connection terminal 152. The first connection terminal 151 has a ground point GP 13 for electrically connecting the ground element 120, and the second connection terminal 152 is an open terminal. In other words, an inductive connection is established between the first connection terminal 151 of the decoupling element 150 and the ground element 120, and a capacitive connection is established between the second connection terminal 152 of the decoupling element 150 and the second antenna element 140.

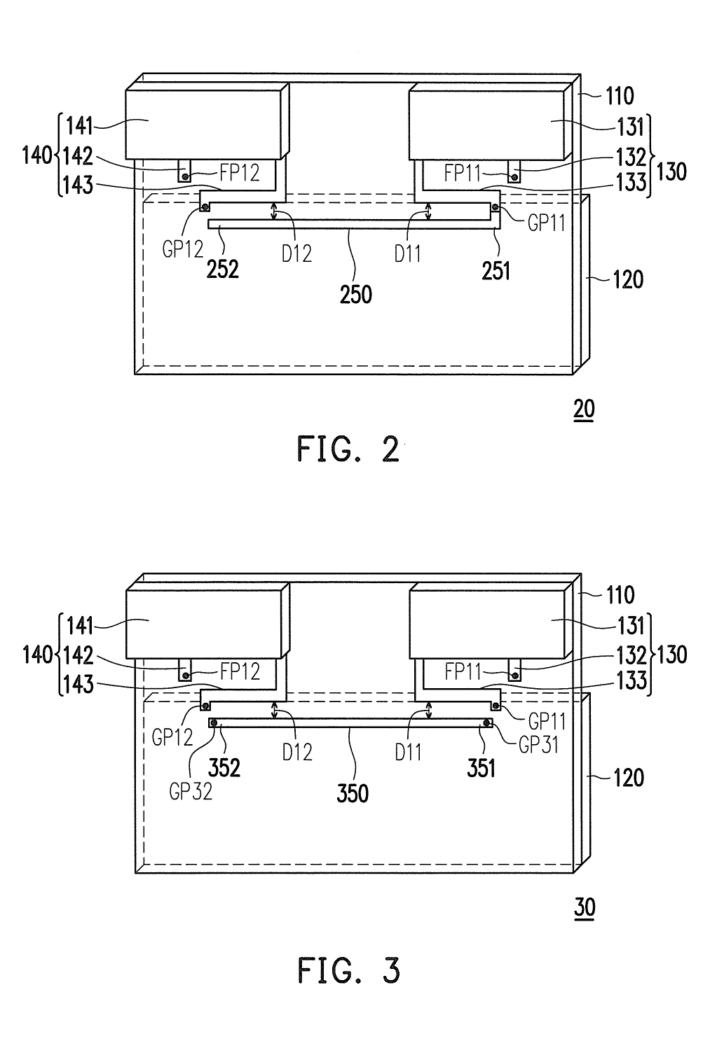

Although the embodiment of FIG. 1A presents a connection type between the decoupling device 150 and the two antenna elements 130 and 140, it is not used to limit the disclosure. For example, FIG. 2 and FIG. 3 are respectively schematic diagrams of a multi-antenna system according to another embodiment of the disclosure. In the embodiment of FIG. 2, a decoupling element 250 of the multi-antenna system 20 has a first connection terminal 251 and a second connection terminal 252, wherein the first connection terminal 251 is electrically connected to the first ground portion 133, and the second connection terminal 252 is an open terminal. The first connection terminal 251 can be electrically connected to the ground element 120 through the first ground point GP11 on the first ground portion 133. In other words, there is an inductive connection between the first connection terminal 251 of the decoupling element 250 and the first antenna element 130, and there is a capacitive connection between the second connection terminal 252 of the decoupling element 250 and the second antenna element 140.

It should be noticed that in another embodiment, connection states of the first connection terminal 251 and the second connection terminal 252 can also be exchanged. Namely, the first connection terminal 251 can be an open terminal, and the second connection terminal 252 is electrically connected to the second ground portion 143. In this way, the decoupling element 250 respectively forms a capacitive connection and an inductive connection with the first antenna element 130 and the second antenna element 140. Detailed descriptions of other elements of the embodiment of FIG. 2 have been described in the above embodiment, and details thereof are not repeated.

In the embodiment of FIG. 3, a decoupling element 350 of the multi-antenna system 30 has a first connection terminal 351 and a second connection terminal 352, wherein the first connection terminal 351 has a ground point GP31 for electrically connecting the ground element 120, and the second connection terminal 352 has another ground point GP32 for electrically connecting the ground element 120. In other words, an inductive connection is established between the first connection terminal 351 of the decoupling element 350 and the ground element 120, and an inductive connection is also established between the second connection terminal 352 of the decoupling element 350 and the ground element 120. Detailed descriptions of other elements of the embodiment of FIG. 3 have been described in the above embodiment, and details thereof are not repeated.

Referring back to FIG. 1A, the decoupling element 150 is, for example, composed of a metal line L1. Moreover, a length of the metal line L1 is smaller than a quarter of the wavelength of the lowest operating frequency of the first antenna element 130. For example, in the present embodiment, the length of the metal line L1 is 1/7 of the wavelength of the lowest operating frequency of the first antenna element 130. Besides, in another embodiment, at least one diode can be inserted to the metal line. In this way, different lengths of the metal line can be switched by turning on/off the diodes, so as to adjust a position of a decoupling frequency.

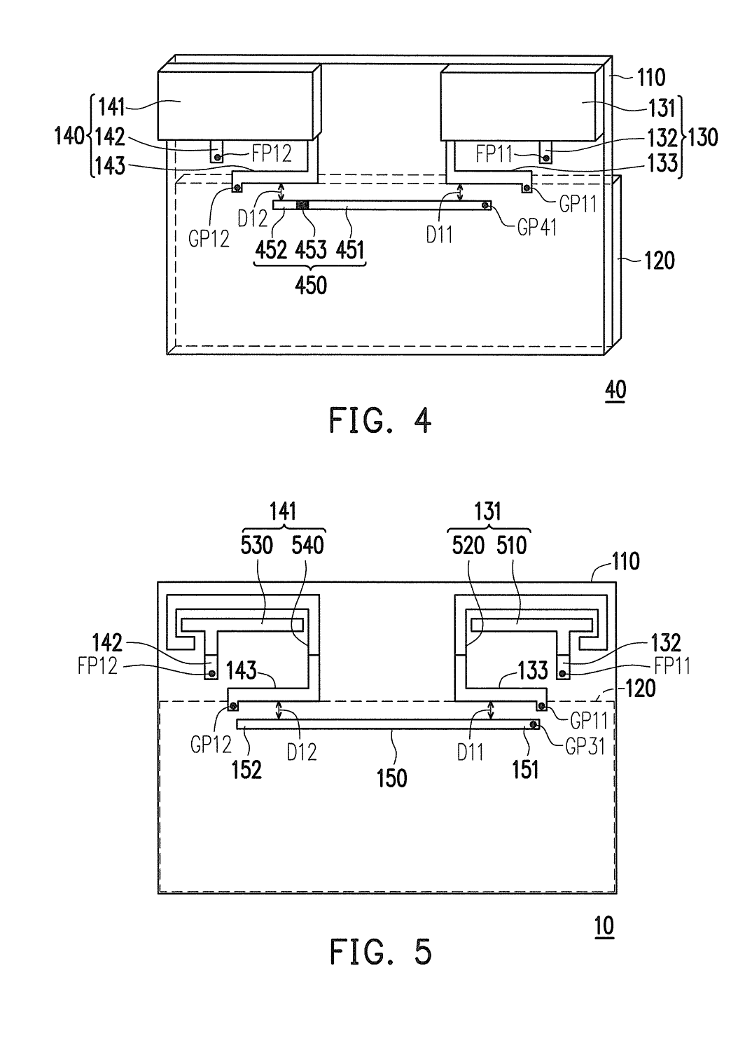

For example, FIG. 4 is a schematic diagram of a multi-antenna system according to still another embodiment of the disclosure. In the embodiment of FIG. 4, a decoupling element 450 of the multi-antenna system 40 includes a first metal line 451, a second metal line 452 and a diode 453. In detail, a first terminal of the first metal line 451 is regarded as a first connection terminal of the decoupling element 450, and the first terminal of the first metal line 451 has a ground point GP41. Moreover, the first metal line 451 and a part of the first ground portion 133 are spaced by the first decoupling distance D11, and the first metal line 451 and a part of the second ground portion 143 are spaced by the second decoupling distance D12.

A first terminal of the second metal line 452 is regarded as a second connection terminal of the decoupling element 450. Moreover, the second metal line 452 and a part of the second ground portion 143 are spaced by the second decoupling distance D12. On the other hand, the diode 453 is electrically connected between a second terminal of the first metal line 451 and a second terminal of the second metal line 452. Accordingly, by turning on/off the diode 453, the length of the metal line extending from the first ground portion 133 to the second ground portion 143 can be switched, so as to adjust the position of the decoupling frequency. Moreover, the first terminal of the first metal line 451 is electrically connected to the ground element 120 through the ground point GP 41, and the first terminal of the second metal line 452 is an open terminal. Moreover, in another embodiment, the first terminal of the first metal line 451 is electrically connected to the first ground portion 133, and the first terminal of the second metal line 452 is an open terminal. Similarly, in another embodiment, the first terminal of the first metal line 451 is an open terminal, and the first terminal of the second metal line 452 is electrically connected to the second ground portion 143.

FIG. 5 is a perspective view of the multi-antenna system of FIG. 1A, in which detailed structures of the first radiation portion 131 and the second radiation portion 141 are illustrated. In detail, in the embodiment of FIG. 5, a planar inverted-F antenna structure is used to implement the first antenna element 130 and the second antenna element 140. Therefore, as shown in FIG. 5, the first radiation portion 131 includes a radiation conductor 510 and a radiation conductor 520. The radiation conductor 510 is electrically connected to the first feeding portion 132, and the radiation conductor 520 is electrically connected to the first ground portion 133 and surrounds the radiation conductor 510. Similarly, the second radiation portion 141 includes a radiation conductor 530 and a radiation conductor 540. The radiation conductor 530 is electrically connected to the second feeding portion 142, and the radiation conductor 540 is electrically connected to the second ground portion 143 and surrounds the radiation conductor 530. Although embodiment of FIG. 5 exemplifies the first antenna element 130 and the second antenna element 140, the disclosure is not limited thereto.

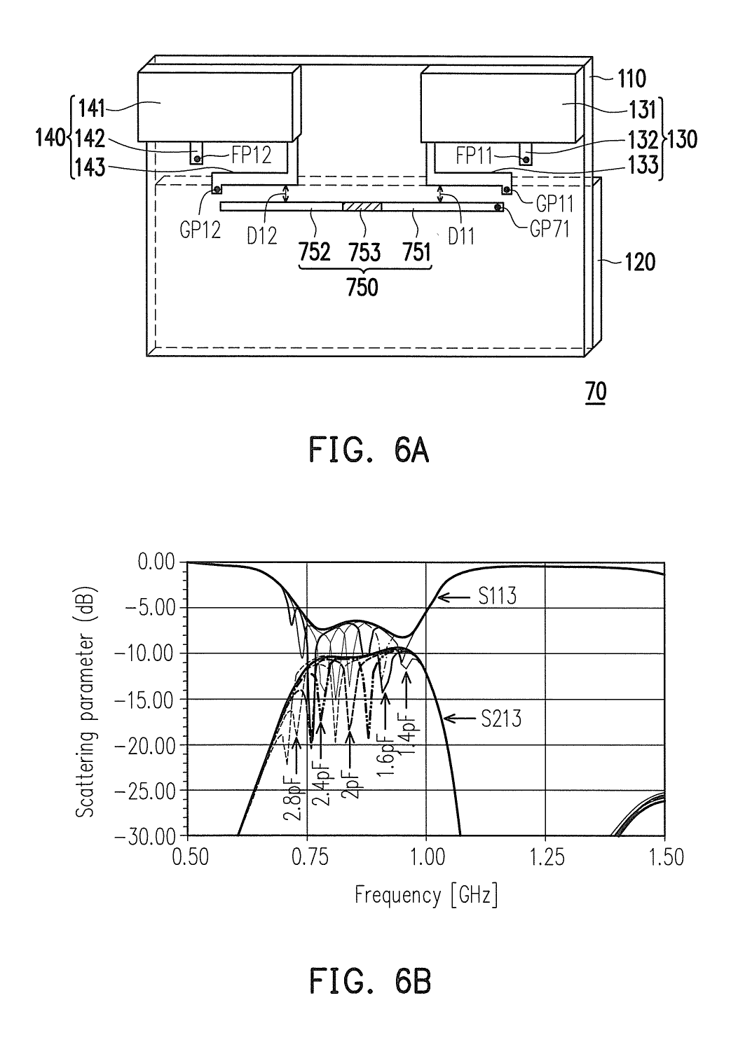

Besides, in order to dynamically adjust the decoupling frequency of the decoupling element, a phase combination structure can be further added to the decoupling element. For example, FIG. 6A is a schematic diagram of a multi-antenna system according to still another embodiment of the disclosure. In the embodiment of FIG. 6A, a decoupling element 750 of the multi-antenna system 70 includes a first metal line 751, a second metal line 752 and a phase combination structure 753. The first metal line 751 and a part of the first ground portion 133 are spaced by the first decoupling distance D11, and the first metal line 751 has a ground point GP71 for electrically connecting the ground element 120. The second metal line 752 and a part of the second ground portion 143 are spaced by the second decoupling distance D12. The phase combination structure 753 is electrically connected between the first metal line 751 and the second metal line 752 for adjusting a phase difference provided by the decoupling element 750.

In an embodiment, the phase combination structure 753 can be a metal line segment, a chip inductor, a chip capacitor or a distributed capacitor or a combination thereof. Moreover, people with ordinary skill in the art can adjust a length of the metal line or adjust an impedance of the chip inductor, the chip capacitor or the distributed capacitor according to a design requirement, so as to adjust the phase difference of the decoupling element 750.

In another embodiment, the phase combination structure 753 can be a variable capacitor. Moreover, the multi-antenna system 70 may adjust the capacitance value of the variable capacitor through a control signal, so as to adjust the phase difference of the decoupling element 750, wherein the variable capacitor can be a radio frequency (RF) microelectromechanical system element. For example, FIG. 6B is a curve diagram of measured scattering parameter of a multi-antenna system according to still another embodiment of the disclosure, in which a curve S113 is used to represent a return loss of the antenna element varied along with the variable capacitance value, and a curve S213 is used to represent isolation of the multi-antenna system 70 varied along with the variable capacitance value. Referring to FIG. 6B, it is known that by adjusting the capacitance value (for example, 2.8 pF, 2.4 pF, 2 pF, 1.6 pF and 1.4 pF in FIG. 6B) of the variable capacitor, a frequency range covered by an isolation frequency band in the multi-antenna system 70 is adjusted, such that the decoupling element 750 has a characteristic of broadband operation.

In order to fully convey the concept of the phase combination structure 753 of the embodiment of FIG. 6A to those with ordinary skill in the art, a detailed structure of the phase combination structure 753 is described below.

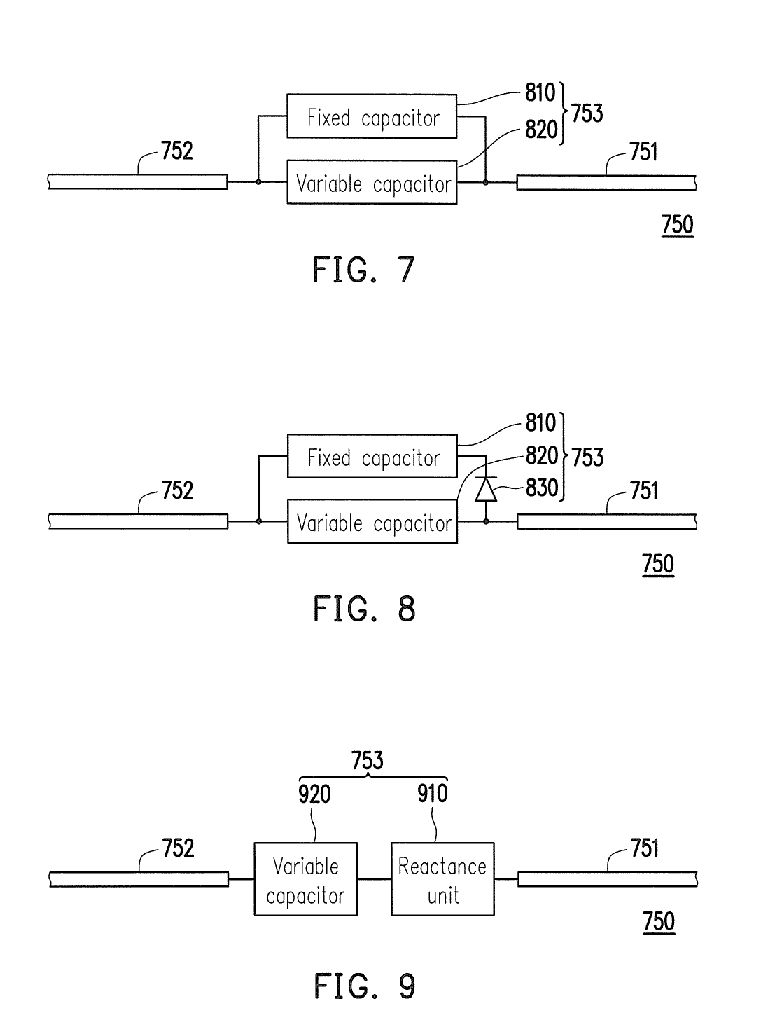

FIG. 7 is a schematic diagram of the phase combination structure according to an embodiment of the disclosure. As shown in FIG. 7, the phase combination structure 753 includes a fixed capacitor 810 and a variable capacitor 820. The fixed capacitor 810 is electrically connected between the first metal line 751 and the second metal line 752, and the variable capacitor 820 and the fixed capacitor 810 are connected in parallel. In view of operation, the multi-antenna system 70 can adjust a capacitance value of the variable capacitor 820 through a control signal, so as to change an equivalent capacitance value between the first metal line 751 and the second metal line 752. Accordingly, the phase difference provided by the decoupling element 750 is changed in response to the equivalent capacitance value.

FIG. 8 is an extending embodiment of the phase combination structure of FIG. 7. Compared to the embodiment of FIG. 7, the phase combination structure 753 of FIG. 8 further includes a diode 830. An anode of the diode 830 is electrically connected to the variable capacitor 820 and the first metal line 751, and a cathode of the diode 830 is electrically connected to the fixed capacitor 810. In view of operation, when the diode 830 is turned on, the variable capacitor 820 and the fixed capacitor 810 are simultaneously connected in parallel between the two metal lines 751 and 752. Now, the equivalent capacitance value provided by the phase combination structure 753 is increased, and the decoupling element 750 may be operated in a lower frequency band. Comparatively, when the diode 830 is turned off, only the variable capacitor 820 is connected between the two metal lines 751 and 752. Now, the equivalent capacitance value provided by the phase combination structure 753 is decreased, and the decoupling element 750 may be operated in a higher frequency band. In other words, by turning on/off the diode 830 in the phase combination structure 753, the decoupling element 750 has a characteristic of dual-band operation.

FIG. 9 is a schematic diagram of a phase combination structure according to another embodiment of the disclosure. Referring to FIG. 9, the phase combination structure 753 includes a reactance unit 910 and a variable capacitor 920. The variable capacitor 920 and the reactance unit 910 are connected in series between the first metal line 751 and the second metal line 752, and the reactance unit 910 can be a fixed capacitor or a fixed inductor. In view of operation, the multi-antenna system 70 can adjust a capacitance value of the variable capacitor 920 through a control signal, so as to change an equivalent reactance value between the first metal line 751 and the second metal line 752. In this way, the phase difference provided by the decoupling element 750 is changed in response to the equivalent reactance value.

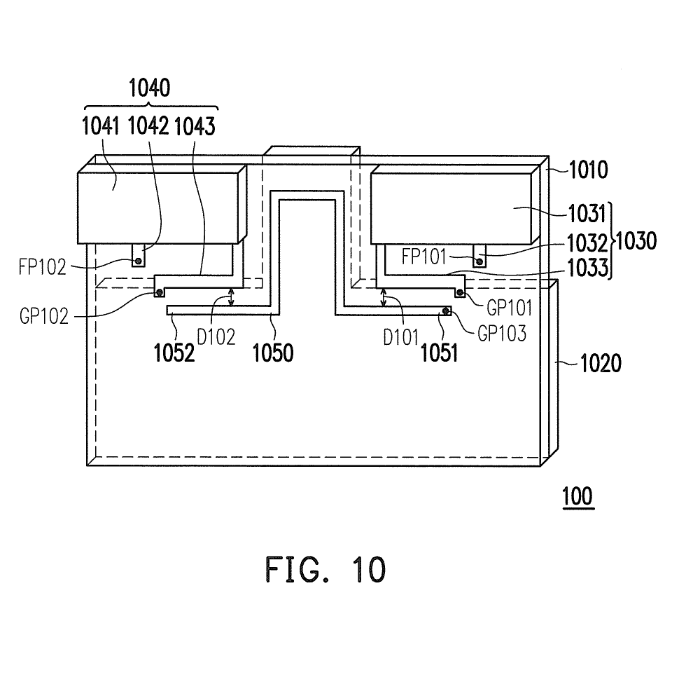

FIG. 10 is a schematic diagram of a multi-antenna system according to still another embodiment of the disclosure. Referring to FIG. 10, the multi-antenna system 100 includes a substrate 1010, a ground element 1020, a first antenna element 1030, a second antenna element 1040 and a decoupling element 1050. The substrate 1010 has a first surface and a second surface. The ground element 1020 is equivalent to a system ground surface of the multi-antenna system 100, and is disposed on the first surface of the substrate 1010. The decoupling element 1050 is disposed on the second surface of the substrate 1010. Moreover, an area on the first surface of the substrate 1010 that is not configured with the ground element 1020 can be regarded as a clearance area of the antenna.

The first antenna element 1030 includes a first radiation portion 1031, a first feeding portion 1032 and a first ground portion 1033, and the second antenna element 1040 includes a second radiation portion 1041, a second feeding portion 1042 and a second ground portion 1043. The first feeding portion 1032 and the second feeding portion 1042 respectively have a feeding point (for example, a first feeding point FP 101 and a second feeding point FP 102) for respectively receiving a feeding signal. The first ground portion 1033 and the second ground portion 1043 respectively have a ground point (for example, a first ground point GP101 and a second ground point GP 102) for electrically connecting the ground element 1020.

The decoupling element 1050 has at least one bending portion, such that a part of the decoupling element 1050 is located between the first antenna element 1030 and the second antenna element 1040. Moreover, the decoupling element 1050 is opposite to the ground element 1020 with the substrate 1010 in between. Namely, the ground element 1020 is disposed under the decoupling element 1050. Moreover, the decoupling element 1050 and a part of the first ground portion 1033 are parallel to each other and are spaced by a first decoupling distance D101, and the decoupling element 1050 and a part of the second ground portion 1043 are parallel to each other and are spaced by a second decoupling distance D102.

A phase difference relative to the first antenna element 1030 and the second antenna element 1040 is generated by the decoupling element 1050, the first decoupling distance D101 and the second decoupling distance D102, so as to effectively decrease interference of resonance mode excited by the two antenna elements 1030 and 1040. In other words, the multi-antenna system 100 can decrease interference energy between the two antenna elements 1030 and 1040 through the decoupling element 1050, so as to improve isolation between the two antenna elements 1030 and 1040.

It should be noticed that the lowest operating frequency of the first antenna element 1030 is not greater than (i.e. smaller than or equal to) that of the second antenna element 1040. Moreover, the first decoupling distance D101 and the second decoupling distance D102 are all smaller than one percent of a wavelength of the lowest operating frequency of the first antenna element 1030. The first ground portion 1033 has a section parallel to the decoupling element 1050, and a length of such section is not smaller than one percent of the wavelength of the lowest operating frequency of the first antenna element 1030. Similarly, the second ground portion 1043 has a section parallel to the decoupling element 1050, and a length of such section is also not smaller than one percent of the wavelength of the lowest operating frequency of the first antenna element 1030.

Further, the decoupling element 1050 has a first connection terminal 1051 and a second connection terminal 1052. The first connection terminal 1051 has a ground point GP103 for electrically connecting the ground element 1020, and the second connection terminal 1052 is an open terminal. Accordingly, an inductive connection is established between the first connection terminal 1051 and the ground element 1020, and a capacitive connection is established between the second connection terminal 1052 and the second antenna element 1040. Moreover, similar to the embodiment of FIG. 2, the first connection terminal 1051 of the decoupling element 1050 can also be electrically connected to the first ground portion 1033, and is electrically connected to the ground element 1020 through the first ground point GP101. Moreover, similar to the embodiment of FIG. 3, the two connection terminals 1051 and 1052 of the decoupling element 1050 can also be electrically connected to the ground element 1020 through a ground point, respectively.

Similar to the embodiment of FIG. 1A, the decoupling element 1050 is, for example, composed of a metal line, and a length of the metal line is smaller than a quarter of the wavelength of the lowest operating frequency of the first antenna element 1030. Moreover, similar to the embodiment of FIG. 4, at least one diode can be inserted to the metal line. In this way, different lengths of the metal line can be switched by turning on/off the diodes, so as to adjust a position of the decoupling frequency.

On the other hand, similar to the embodiment of FIG. 6A, a phase combination structure can be configured in the decoupling element 1050 to dynamically adjust the decoupling frequency of the decoupling element 1050, and a detailed structure of the phase bounding structure is as that described in the embodiments of FIGS. 7-8.

In summary, in the disclosure, the decoupling element is used to decrease the interference energy between the two antenna elements, so as to improve isolation between the two antenna elements. Accordingly, the multi-antenna system can enhance the isolation between the antenna elements without spacing the antennas by a long distance, so as to satisfy the requirements of lightness, slimness, shortness and smallness for the mobile communication devices.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A multi-antenna system, comprising:
a substrate, having a first surface and a second surface;
a ground element, disposed on the first surface;
a first antenna element, comprising a first ground portion electrically connected to the ground element;
a second antenna element, comprising a second ground portion electrically connected to the ground element; and
a decoupling element, disposed on the second surface, and located opposite to the ground element with the substrate in between, wherein the decoupling element has a first connection terminal and a second connection terminal, the first connection terminal is electrically connected to the ground element, the decoupling element and a part of the first ground portion are parallel to each other and are spaced by a first decoupling distance, and the decoupling element and a part of the second ground portion are parallel to each other and are spaced by a second decoupling distance,
wherein a phase difference relative to the first antenna element and the second antenna element is generated by the decoupling element, the first decoupling distance and the second decoupling distance.

2. The multi-antenna system as claimed in claim 1, wherein a lowest operating frequency of the first antenna element is not greater than a lowest operating frequency of the second antenna element, and the first decoupling distance and the second decoupling distance are smaller than one percent of a wavelength of the lowest operating frequency of the first antenna element.

3. The multi-antenna system as claimed in claim 1, wherein the first ground portion has a section parallel to the decoupling element, and a length of the section is not smaller than one percent of a wavelength of a lowest operating frequency of the first antenna element.

4. The multi-antenna system as claimed in claim 1, wherein the second ground portion has a section parallel to the decoupling element, and a length of the section is not smaller than one percent of a wavelength of a lowest operating frequency of the first antenna element.

5. The multi-antenna system as claimed in claim 1, wherein the first antenna element and the second antenna element are disposed on the second surface.

6. The multi-antenna system as claimed in claim 1, wherein the decoupling element has at least one bending portion, such that a part of the decoupling element is located between the first antenna element and the second antenna element.

7. The multi-antenna system as claimed in claim 1, wherein the decoupling element is composed of a metal line.

8. The multi-antenna system as claimed in claim 7, wherein a lowest operating frequency of the first antenna element is not greater than a lowest operating frequency of the second antenna element, and a length of the metal line is smaller than a quarter of a wavelength of the lowest operating frequency of the first antenna element.

9. The multi-antenna system as claimed in claim 1, wherein the first connection terminal is electrically connected to the ground element through the first ground portion.

10. The multi-antenna system as claimed in claim 1, wherein the second connection terminal is an open terminal or is electrically connected to the second ground portion.

11. The multi-antenna system as claimed in claim 1, wherein the decoupling element comprises:
a first metal line, wherein a first terminal of the first metal line is regarded as the first connection terminal, and the first metal line and the part of the first ground portion are spaced by the first decoupling distance, and the first metal line and the part of the second ground portion are spaced by the second decoupling distance;
a second metal line, wherein a first terminal of the second metal line is regarded as the second connection terminal, and the second metal line and the part of the second ground portion are spaced by the second decoupling distance; and
a diode, electrically connected between a second terminal of the first metal line and a second terminal of the second metal line.

12. The multi-antenna system as claimed in claim 1, wherein the second connection terminal of the decoupling element is electrically connected to the ground element.

13. The multi-antenna system as claimed in claim 1, wherein the decoupling element comprises:
a first metal line, spaced the first decoupling distance from the part of the first ground portion;
a second metal line, spaced by the second decoupling distance from the part of the second ground portion; and
a phase combination structure, electrically connected between the first metal line and the second metal line, and configured to adjust the phase difference provided by the decoupling element.

14. The multi-antenna system as claimed in claim 13, wherein the phase combination structure is a metal line segment, a chip inductor, a chip capacitor or a distributed capacitor.

15. The multi-antenna system as claimed in claim 13, wherein the phase combination structure is a variable capacitor, and the multi-antenna system adjusts a capacitance value of the variable capacitor according to a control signal.

16. The multi-antenna system as claimed in claim 13, wherein phase combination structure comprises:
a fixed capacitor, electrically connected between the first metal line and the second metal line; and
a variable capacitor, connected in parallel with the fixed capacitor, and adjusting a capacitance value thereof according to a control signal.

17. The multi-antenna system as claimed in claim 16, wherein the phase combination structure further comprise:
a diode, having an anode electrically connected to the variable capacitor and the first metal line, and a cathode electrically connected to the fixed capacitor.

18. The multi-antenna system as claimed in claim 13, wherein the phase combination structure comprises:
a reactance unit; and
a variable capacitor, wherein the variable capacitor and the reactance unit are coupled in series to each other between the first metal line and the second metal line, and the variable capacitor adjusts a capacitance value thereof according to a control signal.

19. The multi-antenna system as claimed in claim 18, wherein the reactance unit is a fixed capacitor or a fixed inductor.

20. The multi-antenna system as claimed in claim 1, wherein the first antenna element further comprises a first radiation portion and a first feeding portion, and the first feeding portion and the first ground portion are electrically connected to the first radiation portion.

21. The multi-antenna system as claimed in claim 1, wherein the second antenna element comprises a second radiation portion and a second feeding portion, and the second feeding portion and the second ground portion are electrically connected to the second radiation portion.
